(19) United States
(12) Patent Application Publication
(10) Pub. No.: US 2024/0334117 A1
(43) Pub. Date: Oct. 3, 2024

(54) AIR FLOW CONTROL VALVE STRUCTURE FOR AUDIO DEVICE INCLUDING MICROPHONE

(71) Applicant: BUJEON CO., LTD., Ansan-si (KR)

(72) Inventors: Donghyun SEO, Ansan-si (KR); Minkoo PARK, Hwaseong-si (KR)

(21) Appl. No.: 18/609,130

(22) Filed: Mar. 19, 2024

(30) Foreign Application Priority Data
Mar. 28, 2023 (KR) 10-2023-0040418

(51) Int. Cl. H04R 1/28

(52) U.S. Cl. CPC H04R 1/2826

(57) ABSTRACT

The present invention provides an audio device that can selectively allow and block the vent flow of external sound using an air flow control valve mechanism and can finely control the amount of opening.

### CROSS-REFERENCE TO RELATED APPLICATION

This application claims the benefit of Korean Patent Application No. 10-2023-0040418 filed on Mar. 28, 2023, which is hereby incorporated by reference herein in its entirety.

### BACKGROUND

### 1. Technical Field

The present invention relates to an air flow control valve structure for an audio device including a microphone. More specifically, the present invention relates to an audio device that is equipped with a microphone configured to hear a speaker's voice, and an air flow control valve configured to selectively open and close a passage and adjust air flow in order to block or allow external sound. The valve structure of the present invention is particularly suitable for TWS.

### 2. Description of the Related Art

A sound signal transmitted from an external electronic device is converted into vibration through the driver of an earphone equipped with a micro-speaker and this vibration is transmitted through a user's external auditory canal. Accordingly, a user can hear a variety of types of sound, including music, voice, and/or the like. For a wide sound range and excellent sound quality, external noise needs to be prevented from entering the earphone.

However, during daily life or social activities, there are many cases where a user has to listen to the sound transmitted through an earphone and external sound at the same time. These cases correspond to a case where someone calls a user or a user receives a phone call from the outside, a case where a user wants to enjoy music and the sound of nature around him or her at the same time, and a case where a user needs to hear the driving sound of a car to prevent danger on a road. In this case, the state in which external sound is transmitted through the earphone, i.e., a so-called transparency mode, needs to be maintained.

Among currently commercialized products, there are known products in which a user can select an anti-noise cancelling (ANC) mode or a transparency mode through a program of a mobile phone, but most of them add electronic elements such as a filter and a resistor thereto and rely on their physical properties.

There is known a patent document that discloses a mechanical structure that adjusts the passage of air inside an audio device. Korean Patent Application Publication No. 10-2011-0125346 discloses an air control device that includes a rotation plate and a plurality of elongated holes between the back of an earphone and a rear cover and controls the quantity of air flow, and is intended to adjust the amounts of change in the tones of high and low sounds. Korean Patent No. 10-1955108 discloses a switch-type air control valve that is mounted on the speaker of a mobile device. The turning on/off of the valve is adjusted according to the distance between the mobile device and a user, i.e., the volume of sound is increased as the distance from the user increases.

Meanwhile, modern true wireless stereo (TWS) canal-type structures are divided into two types: the type in which there is air flow from an eardrum to the outside; and the type in which there is no air flow when a user wears it. When there is no air flow, the user feels stuffy. In contrast, when there is air flow, external sound can easily enter the eardrum, which can interfere with sound pressure and TWS functionality. Therefore, it is desirable to allow the user or TWS functionality to automatically switch between open and closed modes.

Furthermore, there are many cases where in the case where a surrounding area is noisy when a speaker using TWS is speaking on a phone, external noise flows in into a TWS microphone, so that the TWS microphone does not recognize the speaker's voice well. External noise is not only transmitted through air flow, but also, when there is a speaker in a structure without air flow, it is transmitted to a user through the diaphragm of speaker. The present invention has been conceived to overcome the problems of the prior art.

### SUMMARY

An object of the present invention is to provide an air flow control valve structure for an audio device including a microphone in which the noise transmitted to a diaphragm is fundamentally blocked and allowed by controlling external noise through the adjustment of air flow in front of a speaker and air flow behind the speaker through air flow control valves, thereby improving TWS quality.

In order to accomplish the above object, the present invention provides a true wireless stereo (TWS) speaker, wherein the appearance of the TWS speaker is formed of a housing, the inside of the housing is divided into an upper space and a lower space by a bracket disposed across the longitudinal direction, a driver is disposed on one side of the lower space, and a sound emission portion configured to communicate with the driver and extend forward toward a user's external auditory canal is provided; wherein, in a forward space facing the driver, a microphone is mounted on one side from an inlet of the sound emission portion, and the sound emission portion is blocked by a partition extending to form a boundary of a space formed by the sound emission portion; and whereon the partition forms a channel shape transmitting a speaker's voice to the microphone, and provides a microphone sound inlet portion independent of the sound emission portion.

A first vent hole may be formed in the front surface of the housing, and a first air flow control valve may be formed to selectively open and close the first vent hole and control opening and closing for external sound.

A second vent hole may be formed in a side surface of the housing, and a second air flow control valve may be formed to selectively open and close the second vent hole and control opening and closing for external sound.

A second vent hole may be formed in the side surface of the housing; and a rearward casing may be formed in a rearward portion, which is a portion above the driver, to surround the rearward portion of the driver, a third vent hole may be formed in the rearward casing, and a second air flow control valve configured to selectively open and close the third vent hole may be disposed and control opening and closing for external sound flowing in through the second vent hole.

A second plate-shaped bracket may be installed between both sides of the driver and the inner wall of the housing, a central vent hole may be formed in the bottom surface of the second bracket, and a first air flow control valve configured to selectively open and close the central vent hole may be installed over the central vent hole and control opening and closing for external sound.

A second vent hole may be formed in the side surface of the housing, and a second air flow control valve may be formed to selectively open and close the second vent hole and control opening and closing for external sound.

A second vent hole may be formed in the side surface of the housing; and a rearward casing may be formed in a rearward portion, which is a portion above the driver, to surround the rearward portion of the driver, a third vent hole may be formed in the rearward casing, and a second air flow control valve configured to selectively open and close the third vent hole may be disposed and control opening and closing for external sound flowing in through the second vent hole.

The first air flow control valve may form one of the following states: (A) a closed state for external sound, (B) an intermediately open state for external sound in which a small gap is formed, and (C) a completely open state for external sound in which a large gap is formed.

### BRIEF DESCRIPTION OF THE DRAWINGS

The above and other objects, features, and advantages of the present invention will be more clearly understood from the following detailed description taken in conjunction with the accompanying drawings, in which:

FIG. 1A is an overall perspective view of a TWS speaker to which the air flow control structure of the present invention is applied;

FIG. 1B is an overall perspective view of another TWS speaker to which the air flow control structure of the present invention is applied;

FIG. 2A is a longitudinal sectional view of a TWS speaker according to a first embodiment of the present invention, showing a valve in a closed state;

FIG. 2B is a diagram showing the valve in a half-open state;

FIG. 2C is a diagram showing the valve in a completely open state;

FIG. 3A is a longitudinal sectional view of a TWS speaker according to a second embodiment of the present invention, showing a valve in a closed state;

FIG. 3B is a diagram showing the valve in a half-open state;

FIG. 3C is a diagram showing the valve in a completely open state;

FIG. 4A is a longitudinal sectional view of a TWS speaker according to a third embodiment of the present invention, showing a valve in a closed state;

FIG. 4B is a diagram showing the valve in a half-open state;

FIG. 4C is a diagram showing the valve in a completely open state;

FIG. 5A is a longitudinal sectional view of a TWS speaker according to a fourth embodiment of the present invention, showing a valve in a closed state;

FIG. 5B is a diagram showing the valve in a half-open state, and

FIG. 5C is a diagram showing the valve in a completely open state;

FIG. 6A is a longitudinal sectional view of a TWS speaker according to a fifth embodiment of the present invention, showing a valve in a closed state;

FIG. 6B is a diagram showing the valve in a half-open state; and

FIG. 6C is a diagram showing the valve in a completely open state; and

FIG. 7 is a frequency-sound pressure graph for external sound before and after the application of the valve mechanism of the present invention.

### DETAILED DESCRIPTION

Embodiments of the present invention will be described in detail below with reference to the accompanying drawings.

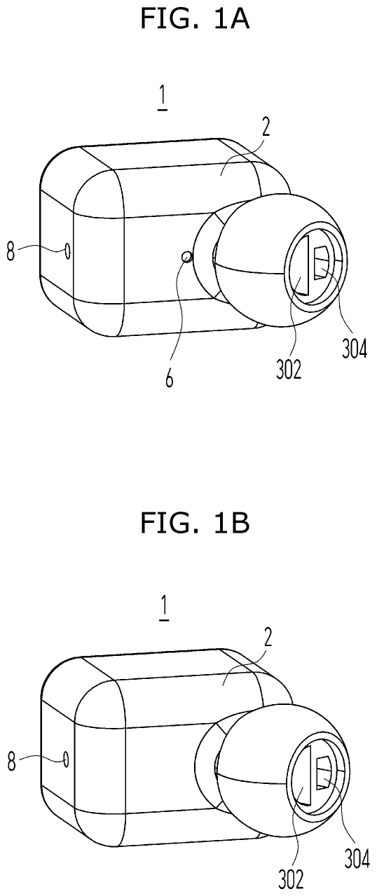

FIG. 1A is an overall perspective view of a TWS speaker 1 to which the air flow control structure of the present invention is applied. The appearance of the TWS speaker 1 is formed of a housing 2 that is configured in an approximately rectangular hexahedral shape. An ear tip covers an outlet portion on one side of the bottom surface of the housing 2. In the outlet portion, there are provided a sound emission portion 302 configured such that the vibration sound of the speaker is emitted to a user's ear canal therethrough, and a microphone sound inlet 304 configured such that the user's (a speaker's) voice is transmitted to the microphone M via the Eustachian tube therethrough.

The TWS speaker 1 has two vent holes 6 and 8. The first vent hole 6 is formed near the center of the front surface of the housing 2 (the side where vibration sound travels toward a user's external auditory canal). The second vent hole 8 is formed at a slightly lower location of a side surface of the housing 2. The present invention selectively blocks and allows the inflow of external sound from the first vent hole 6 or the second vent hole 8 by using an air flow control valve.

FIG. 1B is an overall perspective view of the TWS speaker 1 of another embodiment to which the air flow control structure of the present invention is applied. The TWS speaker of FIG. 1B is different from the TWS speaker of FIG. 1A in that the first vent hole 6 is not formed. In this case, the present invention blocks or allows the inflow of external sound from the second vent hole 8 by using an air flow control valve. There are various embodiments for the TWS speakers 1 having the external appearances of FIGS. 1A and 1B according to the internal structure thereof. In first to fourth embodiments of the present invention to be described below, two air flow control valves are disposed, the valve located relatively forward is called a first air flow control valve, and the valve located relatively rearward is called a second air flow control valve. In the fifth embodiment, one air flow control valve is disposed, and is called a first air flow control valve.

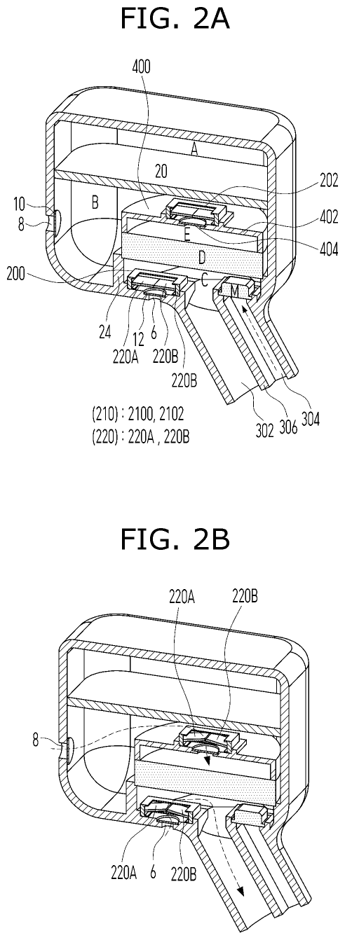

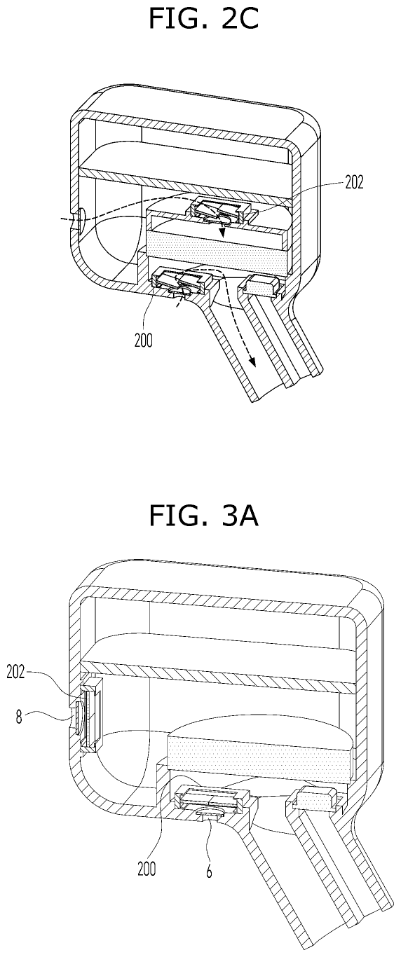

FIG. 2A is a longitudinal sectional view of the TWS speaker 1 of FIG. 1A according to the first embodiment of the present invention.

The inside of the housing 2 of the TWS speaker 1 is divided into an upper space A and a lower space B by a bracket 20 that is a partition wall disposed across the longitudinal direction in the upper portion of the housing 2. Devices and elements for a TWS device, such as a battery and hardware, are placed in the upper space A. The driver D of the speaker is installed in the lower portion of one side of the lower space B.

A sound emission portion 302 is provided to communicate with the driver D. The vibration sound of the diaphragm (not shown) of the driver D is transmitted to a user's external auditory canal through the outlet of the sound emission portion 302. One side of the sound emission portion 302 is blocked by a partition 306 extending long in parallel with a space where it is formed. Between the partition 306 and the inner surface of the housing 2, there is provided a microphone sound inflow portion 304 in the shape of a channel that is smaller in width than the space of the sound emission portion 302 but extends long as well.

In a forward space facing the driver D, a microphone M is mounted on an outer side from the inlet of the sound emission portion 302, i.e., at a location close to the inner surface of the housing 2. The microphone M is supported by the internal structure of the housing and the partition 306. The vibration sound generated from the user's vocal cords is transmitted internally through the microphone sound inflow portion 304, so that the user can clearly hear his or her voice.

Since the sound emission portion 302 and the microphone sound inflow portion 304 are blocked by the partition 306, sounds exiting or entering the two elements are transmitted independently and are not mixed with each other.

The driver D is supported by a partition wall 24 on the side opposite to the microphone M, and is blocked from the lower space B. The forward vibration sound of the driver D is emitted through the sound emission portion 302 without leaking into the lower space B.

The above-described second vent hole 8 is formed in a side surface of the lower space B. A second mesh 10 is installed over the second vent hole 8.

The first vent hole 6 is formed near the center of the bottom surface of the housing 2, specifically between the partition wall 24 and the inlet of the sound emission portion 302. A first mesh 12 is installed to cover the first vent hole 6. The first vent hole 6 is formed on the side facing the user, in which case the first vent hole 6 is formed in the “front” or “front side” of the housing 2.

In the present invention, a front space C which is separated from the lower space B and through which vibration sound is emitted is formed by the driver D and the partition wall 24. The front space C is a space open downward (forward) because it is separated from the lower space B by the boundary formed by the partition wall 24 and the lowermost surface of the driver D but includes the sound emission portion 302.

In addition, there is formed a downwardly open second forward space F which is separated from the front space C and through which a speaker's sound is transmitted by the microphone M and the partition 306.

The present invention is characterized in that there is provided a first air flow control valve 200 surrounding the first vent hole 6. The first air flow control valve 200 includes a valve housing 210, and valve flaps 220 installed inside the valve housing 210. The valve housing 210 includes a side surface 2100 and a top surface 2102. The side surface 2100 is erected to surround the first vent hole 6, and the top surface 2102 is formed of an edge and is mostly open. The valve flaps 220 include a first flap 220A formed on one side surface 2100, and a second flap 220B formed on the other side surface 2100 to face the first flap 220A. The first flap 220A and the second flap 220B may be moved in response to the reception of driving force from an actuator (not shown) of the air flow control valve.

In FIG. 2A, the first flap 220A and the second flap 220B maintain a straight shape parallel to the bottom surface of the housing 2 without being off-centered upward or downward. Furthermore, the ends of the two flaps are completely in contact with each other and form a closed state that maintains airtightness. In this state, even when external sound flows in through the first vent hole 6, it is blocked by the side surface 2100 and the first and second flaps A and B, so that it can no longer flow inward.

Additionally, in the present invention, a rearward casing 400 is formed in a rearward portion, which is a portion above the driver D, to surround an overall portion behind the driver D. The top portion 402 of the rearward casing 400 is spaced apart from the rear surface of the driver D by a predetermined distance, and a rearward sound chamber E, which is an empty space, is provided between the rearward casing 400 and the driver D. A third vent hole 404 is formed near the center of the top portion 402, and a second air flow control valve 202 is provided to surround the third vent hole 404 above the third vent hole 404. The structure of the second air flow control valve 202 is the same as that of the first air flow control valve 200. In this state, the ends of the two flaps come into complete contact with each other and form a closed state that maintains airtightness, so that, even when external sound flows in through the second vent hole 8, it is not transmitted to the driver D.

The rearward casing 4 blocks the portion behind the driver from other spaces (in a closed state), but may keep the portion behind the driver open by switching to a half-open or completely open state. The volume of the rearward sound chamber E is determined not only from the perspective of blocking external sounds, but also by considering the effect of rearward emitted sound from the diaphragm of the driver D on sound quality.

The closed state of FIG. 2A is a state in which the transmission of external sound is blocked to the maximum because both the first and second air flow control valves 200 and 202 are closed. In this state, a user may hear the voice coming from the microphone M as well as the emitted sound of the driver D without interference with external noise.

FIG. 2B is a diagram showing an intermediately open stage for external sound in FIG. 2A.

In the intermediate stage in which overall external sound is not blocked but a sound passage is not all open, the first flap 220A and the second flap 220B are simultaneously rotated upward by the same angle, as shown in the drawing. A small gap is formed between the ends of the two flaps. In this state, when external sound flows in through the first vent hole 6, it passes through the gap formed between the first and second flaps A and B, then passes through the opening of the top surface 2102 and is finally transmitted to a user's external auditory canal through the sound emission portion 302. The external sound transmitted is not the noise heard from outside, but is sound having a reduced volume. Some of the external sound flowing in through the second vent hole 8 flows into the rearward sound chamber E through the second air flow control valve 202, which is in a half-open state. The incoming external sound affects the diaphragm of the driver D.

Unlike in the above example, both the first and second flaps 220A and 220B may be rotated downward. Alternatively, the position of one of the two flaps may be fixed, and the remaining flap may be rotated up or down.

FIG. 2C is a diagram showing a completely open stage for external sound in FIG. 2A.

In the stage in which a sound passage is open for overall external sound, the first flap 220A is rotated downward and the second flap 220B is rotated upward, as shown in the drawing. A large gap is formed between the ends of the two flaps. In this state, when external sound flows in through the first vent hole 6, it passes through the large gap formed between the first and second flaps A and B, then passes through the opening of the top surface 2102, and is transmitted to a user's external auditory canal through the sound emission portion 4. The external sound transmitted is less than the noise heard from outside, but the maximum volume thereof is higher than the sound pressure in a closed or semi-open state. Some of the external sound flowing in through the second vent hole 8 flows into the rearward sound chamber E through the second air flow control valve 202, which is fully open. The incoming external sound affects the diaphragm of the driver D.

Unlike in the above example, the first flap 220A may be rotated upward, and the second flap 220B may be rotated downward. Furthermore, although the flap rotation type has been described above, a structure in which the open area between the two members is adjusted in such a manner that the first flap 220A and the second flap 220B are selectively moved adjacent to each other or spaced apart from each other on the same plane is also possible.

In addition, the intermediately open stage does not necessarily mean a single stage. The degree of valve opening may be changed according to the performance and operation of the TWS or audio, and multiple intermediately open stages may be set up.

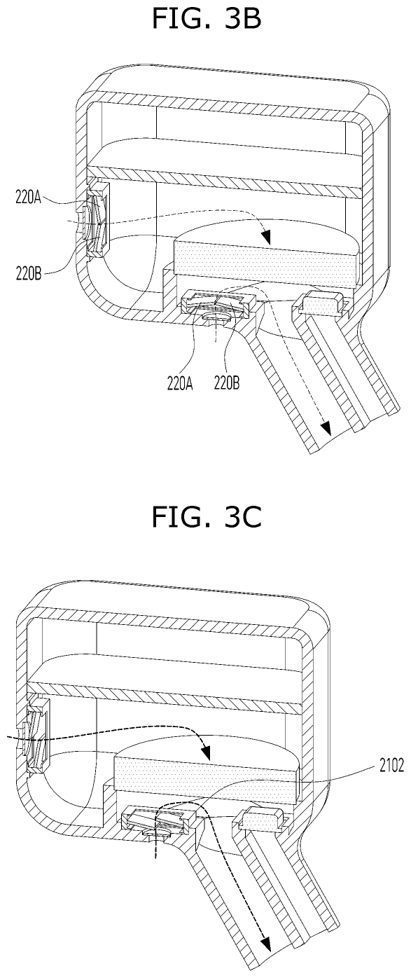

FIG. 3A is a longitudinal sectional view of the TWS speaker 1 of FIG. 1A according to a second embodiment of the present invention. The second embodiment is different from the first embodiment in that the second air flow control valve 202 is installed on the inner surface of the housing to surround the second vent hole 8 rather than having a separate structure behind the driver D.

The closed state of FIG. 3A is a state in which the transmission of external sound is blocked to the maximum because both the first and second air flow control valves 200 and 202 are closed. In this state, a user may hear the voice coming from the microphone M as well as the emitted sound of the driver D without interference with external noise.

FIG. 3B is a diagram showing an intermediately open stage for external sound in FIG. 3A.

In the intermediate stage in which external sound is not all blocked but is not all allowed, the first flap 220A and the second flap 220B are rotated by the same angle in one direction at the same time and form a small gap between the ends of the two flaps, as shown in the drawing. When external sound flows in through the first vent hole 6, it passes through the gap formed between the first and second flaps A and B, then passes through the opening of the top surface 2102, and is transmitted to the user's ear canal through the sound emission portion 4. The external sound flowing in through the second vent hole 8 flows into the lower space B.

FIG. 3C is a diagram showing a completely open stage for external sound in FIG. 3A.

In the stage where overall external sound is allowed, the first flap 220A is rotated in one direction, and the second flap 220B is rotated in the opposite direction, as shown in the drawing. A large gap is formed between the ends of the two flaps. In this state, when external sound flows in through the first vent hole 6, it passes through the large gap formed between the first and second flaps A and B, then passes through the opening of the top surface 2102, and is transmitted to the user's external auditory canal through the sound emission portion 4. The external sound flowing in through the second vent hole 8 flows into the lower space B. Compared to that in the semi-open state, the volume of external sound coming in is larger.

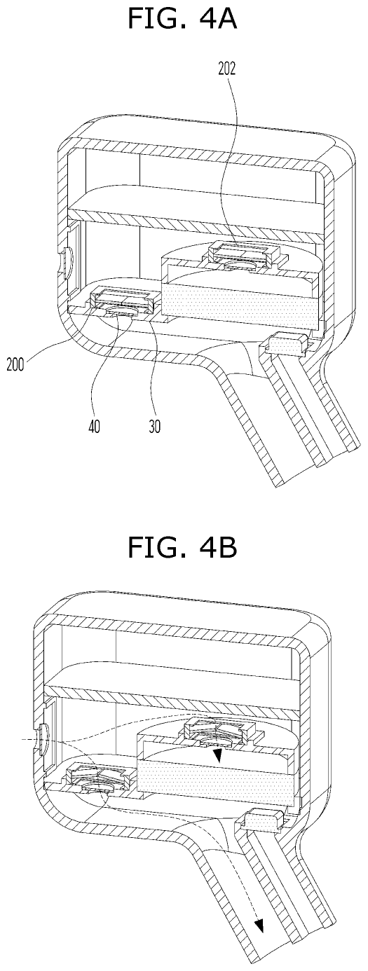

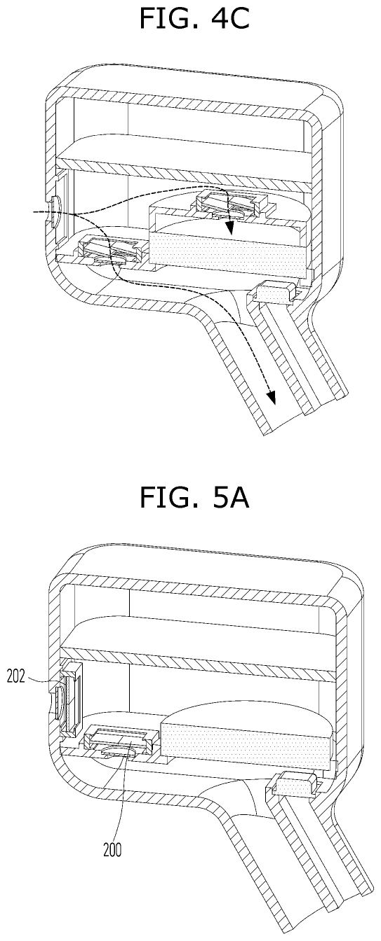

FIG. 4A is a longitudinal sectional view of the TWS speaker 1 of FIG. 1B according to a third embodiment of the present invention.

The third embodiment is different from the first embodiment in that a first vent hole 6 is not formed in the front surface of a housing 2. The structures and functions of first and second air flow control valves 200 and 202 are the same as those of the first embodiment.

A plate-shaped second bracket 30 is disposed between both side surfaces of a driver D and the inner wall of a housing 2. The second bracket 30 is installed slightly below the front surface (lowest bottom) of the driver D and at a height that completely exposes a second vent hole 8 in order to prevent interference with the sound emission of the driver D. A central vent hole 40 is formed near the center of the bottom surface of the second bracket 30. A central mesh is disposed to cover the central vent hole 40. In the same manner as that of the previous embodiment, a valve structure 200 surrounding the central vent hole 40 is provided.

In FIG. 4A, the first flap 220A and the second flap 220B maintain a straight shape parallel to the bottom surface of the housing 2 without being off-centered upward or downward, and form a closed state in which the ends of the two flaps are completely in contact with each other and maintain airtightness.

FIG. 4B is a diagram showing an intermediately open stage for external sound in FIG. 4A.

In the intermediate stage in which overall external sound is not blocked but a sound passage is not all open, the first flap 220A and the second flap 220B are simultaneously rotated by the same angle in one direction and thus a small gap is formed between the ends of the two flaps.

FIG. 4C is a diagram showing a completely open stage for external sound in FIG. 4A.

In the stage in which a sound passage is open for overall external sound, the first flap 220A is rotated in one direction and the second flap 220B is rotated in the opposite direction, thereby forming a large gap between the ends of the two flaps, as shown in the drawing.

The air flow functionality for external sound of FIGS. 4B and 4c is the same as the embodiment of FIGS. 2B and 2C except for the order in which external sound flows in through the second vent hole 8, first passes through the open top surface of the valve housing 210 and then flows into the central vent hole 40. Accordingly, a detailed description thereof is omitted.

In any embodiment of the present invention, there is used a structure in which the flow of external sound is formed inside the front space C and the external sound is merged with the vibration sound of the driver D.

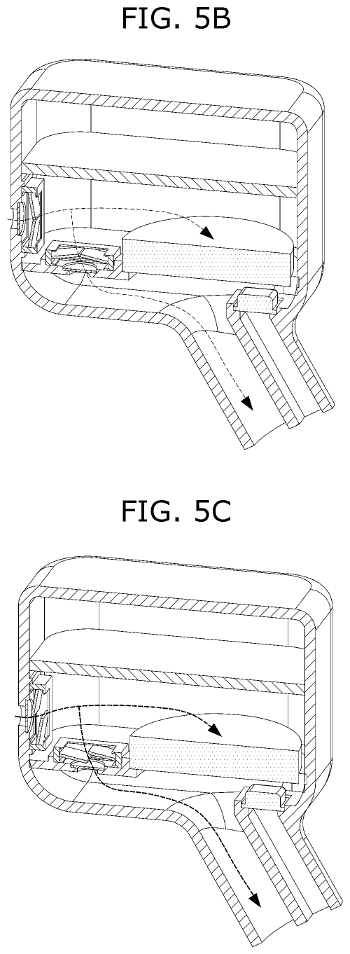

FIG. 5A is a longitudinal sectional view of the TWS speaker 1 of FIG. 1B according to the fourth embodiment of the present invention, which shows the state in which first and second air flow control valves 200 and 202 are closed. FIG. 5B shows an intermediately open stage for external sound in FIG. 5A. FIG. 5C shows a completely open stage for external sound in FIG. 5A.

The fourth embodiment is different from the previous third embodiment in that the rearward casing 4 and the rearward sound chamber E are not formed and a second air flow control valve 202 is disposed to cover a second vent hole 8. Since the functions of the first and second air flow control valves 200 and 202 and the flows of external sound are basically the same as those of the third embodiment, detailed descriptions are omitted.

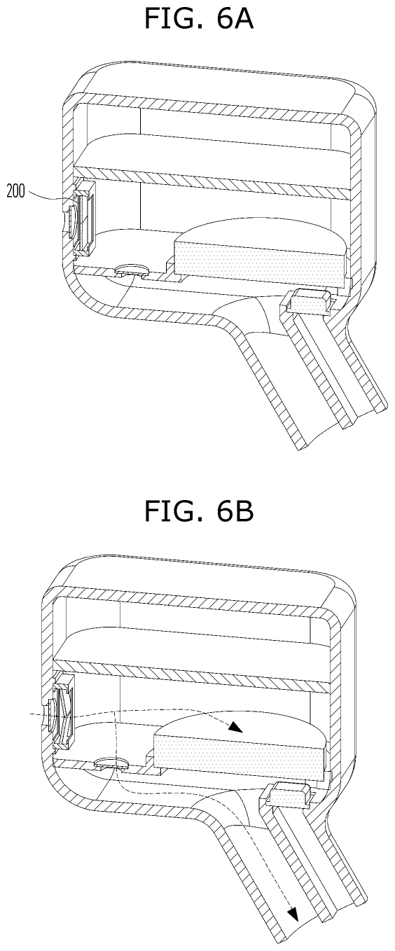

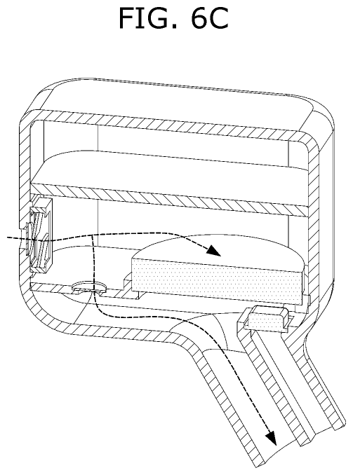

FIG. 6A is a longitudinal sectional view of the TWS speaker 1 of FIG. 1B according to the fifth embodiment of the present invention, which shows the state where a first air flow control valve 200 is closed. FIG. 6B shows an intermediately open stage for external sound in FIG. 6A. FIG. 6C shows a completely open stage for external sound in FIG. 6A.

The fifth embodiment is different from the previous fourth embodiment in that only one first air flow control valve 200 is installed at a position covering a second vent hole 8. Since the functionality of the first air flow control valve 200 and the flow of external sound are basically the same as those of the fourth embodiment, detailed descriptions thereof will be omitted.

In the above example, the case where the first air flow control valve 200 and the second air flow control valve 202 are simultaneously in the same state—in a closed state, a half-open state, or a completely open state—has been described. The open/closed state may be controlled in different manners, such as not only opening or closing both the air flow control valves, but also opening the first air flow control valve 200 and closing the second air flow control valve 202, or conversely, closing the first air flow control valve 200 and opening the second air flow control valve 202.

In addition, although the air flow control valve has been mainly described as surrounding or covering the vent hole, valves having various structures, such as those configured to selectively open and close a vent hole by approaching or being spaced apart from the vent hole, may be used.

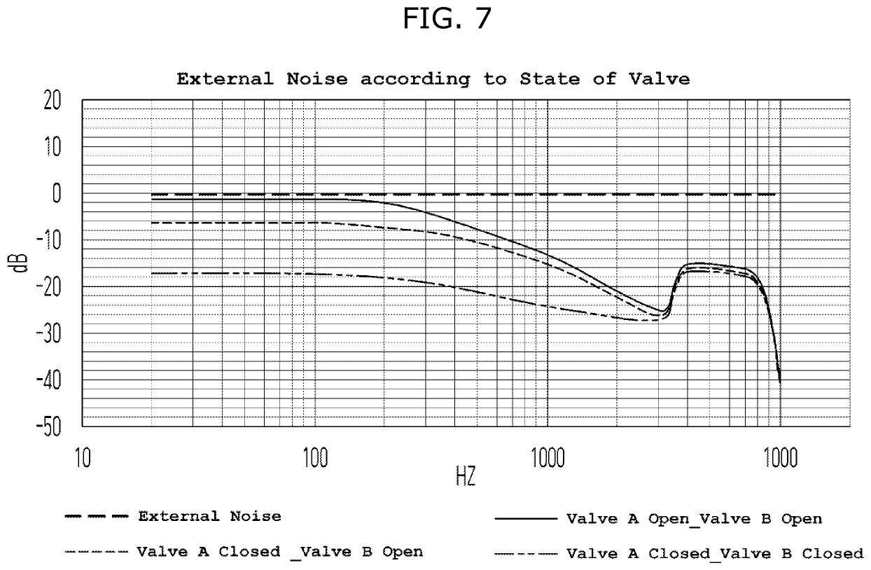

FIG. 7 is a frequency-sound pressure graph in the case where the valve structure of the second embodiment of the present invention is applied to a TWS speaker when external noise is set to a reference decibel.

“Valve A” is the first air flow control valve 200 installed in the first vent hole 6, and “valve B” is the second air flow control valve 202 installed in the second vent hole 8.

It can be seen that in the state where two valves are closed, the sound pressure of external sound decreases across all frequency ranges and a reduction effect increases as the frequency increases. In the half-open state where the valve of the first vent hole 6 is opened and the valve of the second vent hole 8 is closed, it can be seen that the same shape is obtained as the sound pressure graph in the closed state and the effect of reducing external sound is small. In the state where the two valves are opened, it can be seen that the same shape is obtained as the sound pressure graph in the half-open state and the effect of reducing external sound is naturally smaller than that.

The present invention allows a user to conveniently adjust the level of hearing external sound by adjusting the opening and closing and inflow of external sound in any embodiment. When external sound is blocked, the inflow of noise may be prevented by performing reliable blocking. Since an inflow path through which a speaker's voice is transmitted and a path through which a speaker's vibration sound is emitted are formed to be independent of each other, a microphone may perform excellent voice recognition without interference with external sound.

According to the present invention, when external sound is loud, it is fundamentally blocked through the air flow control valve. When a speaker produces voice, only the pure speaker's voice may be transmitted to the TWS microphone. In this case, the speaker's voice is not mixed with external noise, thereby providing an advantage in which voice recognition is excellent.

According to the present invention, when it is necessary to introduce external sound (when a function such as conversation with people next to a user or listening to surrounding sounds is required), the air flow control valve is opened, so that there is provided the advantage of enabling natural sound hearing and conversation.

According to the present invention, external noise is fundamentally blocked or allowed by adjusting air flows in front of and behind the speaker, so that there is provided the advantage of significantly improving the quality of speaker sound, listening to ambient sound, and a speaker's voice.

Although the embodiments of the present invention have been described above, it is obvious that various changes and modifications may be made to the present invention and that the scope of the rights of the present invention extends to an identical or equivalent range as the claims to be described below.

What is claimed is:

1. A true wireless stereo (TWS) speaker, wherein an appearance of the TWS speaker is formed of a housing, an inside of the housing is divided into an upper space and a lower space by a bracket disposed across a longitudinal direction, a driver is disposed on one side of the lower space, and a sound emission portion configured to communicate with the driver and extend forward toward a user's external auditory canal is provided;
wherein, in a forward space facing the driver, a microphone is mounted on one side from an inlet of the sound emission portion, and the sound emission portion is blocked by a partition extending to form a boundary of a space formed by the sound emission portion; and
whereon the partition forms a channel shape transmitting a speaker's voice to the microphone, and provides a microphone sound inlet portion independent of the sound emission portion.

2. The TWS speaker of claim 1, wherein a first vent hole is formed in a front surface of the housing, and a first air flow control valve is formed to selectively open and close the first vent hole and controls opening and closing for external sound.

3. The TWS speaker of claim 2, wherein a second vent hole is formed in a side surface of the housing, and a second air flow control valve is formed to selectively open and close the second vent hole and controls opening and closing for external sound.

4. The TWS speaker of claim 2, wherein:
a second vent hole is formed in a side surface of the housing; and
a rearward casing is formed in a rearward portion, which is a portion above the driver, to surround the rearward portion of the driver, a third vent hole is formed in the rearward casing, and a second air flow control valve configured to selectively open and close the third vent hole is disposed and controls opening and closing for external sound flowing in through the second vent hole.

5. The TWS speaker of claim 1, wherein a second plate-shaped bracket is installed between both sides of the driver and an inner wall of the housing, a central vent hole is formed in a bottom surface of the second bracket, and a first air flow control valve configured to selectively open and close the central vent hole is installed over the central vent hole and controls opening and closing for external sound.

6. The TWS speaker of claim 5, wherein a second vent hole is formed in a side surface of the housing, and a second air flow control valve is formed to selectively open and close the second vent hole and controls opening and closing for external sound.

7. The TWS speaker of claim 5, wherein:
a second vent hole is formed in a side surface of the housing; and
a rearward casing is formed in a rearward portion, which is a portion above the driver, to surround the rearward portion of the driver, a third vent hole is formed in the rearward casing, and a second air flow control valve configured to selectively open and close the third vent hole is disposed and controls opening and closing for external sound flowing in through the second vent hole.

8. The TWS speaker of claim 2, wherein the first air flow control valve forms one of the following states: (A) a closed state for external sound, (B) an intermediately open state for external sound in which a small gap is formed, and (C) a completely open state for external sound in which a large gap is formed.

9. The TWS speaker of claim 3, wherein the first air flow control valve forms one of the following states: (A) a closed state for external sound, (B) an intermediately open state for external sound in which a small gap is formed, and (C) a completely open state for external sound in which a large gap is formed.

10. The TWS speaker of claim 4, wherein the first air flow control valve forms one of the following states: (A) a closed state for external sound, (B) an intermediately open state for external sound in which a small gap is formed, and (C) a completely open state for external sound in which a large gap is formed.

11. The TWS speaker of claim 5, wherein the first air flow control valve forms one of the following states: (A) a closed state for external sound, (B) an intermediately open state for external sound in which a small gap is formed, and (C) a completely open state for external sound in which a large gap is formed.

12. The TWS speaker of claim 6, wherein the first air flow control valve forms one of the following states: (A) a closed state for external sound, (B) an intermediately open state for external sound in which a small gap is formed, and (C) a completely open state for external sound in which a large gap is formed.

13. The TWS speaker of claim 7, wherein the first air flow control valve forms one of the following states: (A) a closed state for external sound, (B) an intermediately open state for external sound in which a small gap is formed, and (C) a completely open state for external sound in which a large gap is formed.

14. The TWS speaker of claim 3, wherein the second air flow control valve forms one of the following states: (A) a closed state for external sound, (B) an intermediately open state for external sound in which a small gap is formed, and (C) a completely open state for external sound in which a large gap is formed.

15. The TWS speaker of claim 4, wherein the second air flow control valve forms one of the following states: (A) a closed state for external sound, (B) an intermediately open state for external sound in which a small gap is formed, and (C) a completely open state for external sound in which a large gap is formed.

16. The TWS speaker of claim 6, wherein the second air flow control valve forms one of the following states: (A) a closed state for external sound, (B) an intermediately open state for external sound in which a small gap is formed, and (C) a completely open state for external sound in which a large gap is formed.

17. The TWS speaker of claim 7, wherein the second air flow control valve forms one of the following states: (A) a closed state for external sound, (B) an intermediately open state for external sound in which a small gap is formed, and (C) a completely open state for external sound in which a large gap is formed.
